(19) United States
(12) Patent Application Publication
(10) Pub. No.: US 2012/0066025 A1
(43) Pub. Date: Mar. 15, 2012

(54) ASSESSING ADOPTION OR UTILIZATION OF A MEDICAL PRODUCT

(75) Inventor: Christopher J. Quinn, Durham, NC (US)

(73) Assignee: Clarusnostics, LLC, Durham, NC (US)

(21) Appl. No.: 13/228,631

(22) Filed: Sep. 9, 2011

Related U.S. Application Data
(60) Provisional application No. 61/381,178, filed on Sep. 9, 2010.

(51) Int. Cl. G06Q 10/00

(52) U.S. Cl. 705/7.31

(57) ABSTRACT

In various embodiments, the present disclosure provides systems, computer-readable media and methods for assessing adoption or utilization of a medical product. In various embodiments, a request for observations by the sales representative relating to a plurality of observable factors that potentially influence adoption or utilization of the medical product by one or more providers may be caused to be presented to a sales representative for the medical product, at a computer system of the sales representative. In various embodiments, numeric data corresponding to observations by the sales representative relating to the plurality of observable factors may be received. In various embodiments, assessment of the numeric data may be facilitated to identify one or more observed factors of the plurality of observable factors that influence adoption or utilization of the medical product.

### CROSS REFERENCE TO RELATED APPLICATIONS

This application claims priority under 35 U.S.C. §119(e) to U.S. Provisional Patent Application No. 61/381,178 entitled “SYSTEM AND METHOD FOR ASSESSING READINESS TO ADOPT MEDICAL PRODUCTS,” filed Sep. 9, 2010, the disclosure of which is incorporated herein by reference.

### TECHNICAL FIELD

Embodiments of the present disclosure relate generally to the technical field of data processing, and more specifically to assessing adoption or utilization of a medical product.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Launching a new medical product such as a pharmaceutical or a medical device can be very expensive. Medical products typically require enormous investment in research and development. In many cases, approval is required from authorities such as the Food and Drug Administration before a medical product may be released, and obtaining such approval can be an expensive and time-consuming process.

The trajectory of adoption of a new medical product often is ascertainable within a particular period of time from the initial launch. For example, it has been observed that the trajectory of sales of a newly launched medical product tends to level out after six months, and that 65-75% of all launched medical products thereafter either remain at the same level of usage or move down from where they were at six months.

Accordingly, before a new medical product is launched, many producers such as pharmaceutical companies or medical device manufacturers attempt to forecast how the medical product may be accepted by providers such as physicians. Such a forecast may be based on many variables, such as past performance of similar medical products, a physician's stated intentions regarding utilization or adoption of a medical product, the methods used to promote those past medical products, market conditions, and so forth.

A shortcoming of current forecasting methods to gauge medical product adoption and utilization rates is that the methods are not diagnostic. They provide medical product companies with information as to what happened (e.g., number of new prescriptions versus total prescriptions), but not why it occurred. This makes responding to physician product adoption and/or utilization issues challenging.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

FIG. 1 schematically illustrates a system in accordance with various embodiments of the disclosure.

FIG. 2 depicts an example overview of how adoption or utilization of a medical product may be assessed, in accordance with various embodiments.

FIGS. 3-4 depict an example method of collecting sales representative observations and assessing data, in accordance with various embodiments.

FIG. 5 depicts an example interface that may be presented to a sales representative of a medical product, in accordance with various embodiments.

FIG. 6 depicts the example interface of FIG. 5, with an additional request for level of agreement by a sales representative, in accordance with various embodiments.

FIG. 7 depicts an example chart, in accordance with various embodiments depicting assessment results for a plurality of observable factors.

FIGS. 8-11 depict example tables showing relationships that may be used in computations for assessing adoption or utilization of a medical product, in accordance with various embodiments.

FIG. 12 depicts an example chart, in accordance with various embodiments.

FIG. 13 schematically depicts an example system on which various disclosed methods and techniques may be implemented, in accordance with various embodiments.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

As used herein, the term “medical product” may refer to pharmaceuticals, medical devices, diagnostic assays/tests, therapy devices, and other products intended for sale to health professionals for the purpose of treating patients. As used herein, the term “provider” may refer to anyone who provides/prescribes medical products, such as a physician, a nurse, a nurse practitioner, a clinician, a chiropractor, a therapist, and so forth.

In providing some clarifying context to language that may be used in connection with various embodiments, the phrases “NB” and “A and/or B” mean (A), (B), or (A and B); and the phrase “A, B, and/or C” means (A), (B), (C), (A and B), (A and C), (B and C) or (A, B and C).

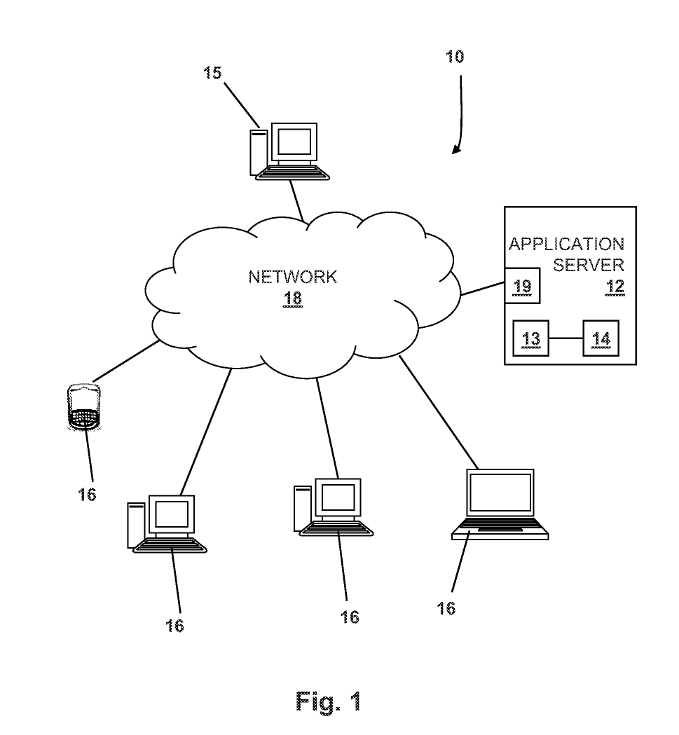

Referring now to FIG. 1, a system 10 may include one or more application servers 12 (which may include one or more processors 13 operably coupled to non-transitory computer-readable memory 14), one or more medical product launcher computer systems 15, and one or more medical product sales representative computer systems 16. One or more of these components may be in communication over one or more computer networks 18. For example, application computer system 12 may include one or more network interfaces 19. Other computer systems may similarly include network interfaces. Computer network 18 may include one or more local or wide area computer networks, such as the Internet, and may include wired and/or wireless components.

While shown as a single computer system, application server 12 may be implemented on any number of computer systems. In some embodiments, medical product launcher computer system 15 and application server 12 may operate on the same computer system. Medical product launcher computer system 15 and/or medical product sales representative computer systems 16 may be any type of computer system, such as a desktop, laptop, smart phone, portable digital assistant, set-top box, and any other computer system that may be used by a medical product sales representative to input or assess data, by a medical product launcher to assess or manipulate data.

In various embodiments, application data server 12 may operate or be operatively coupled to one or more databases (not shown). These databases may be relational databases or other types of databases. Although not shown in FIG. 1, a separate database server may also be used, and may be in communication with application server 12 over one or more networks, such as computer network 18.

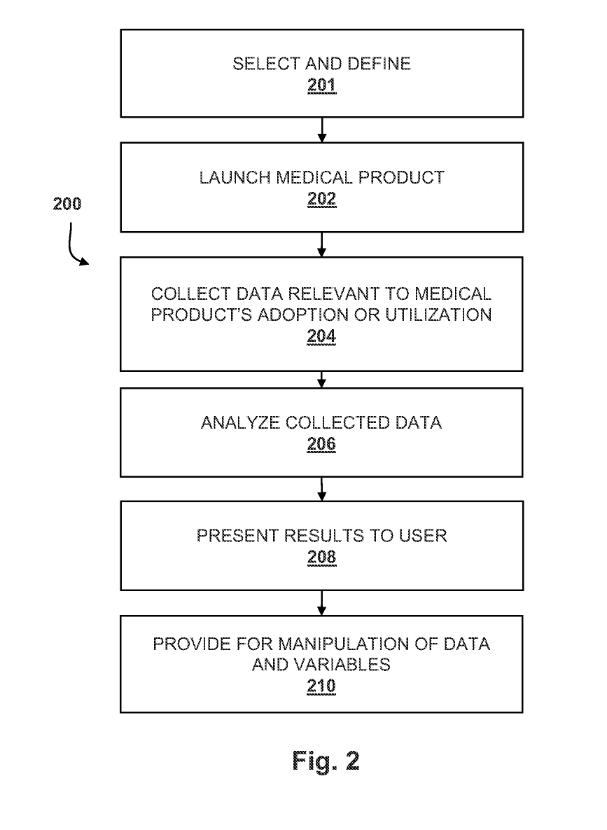

Determining and/or analyzing adoption or utilization of medical products may generally follow the flow 200 shown in FIG. 2. At 201, a medical product company or producer may identify and/or define a plurality of observable factors that may be relevant for the target product/market situation for new product launches or existing products. The relative importance for each of the observable factors selected for a given product/market may be established and input into a computer system such as application server 12 and/or product launcher computer system 15. For example, an observable factor related to perceived clinical utility of a medical product may be particularly important to adoption or utilization of an alternative medicine medical product. As used herein, “observable factors” and “observed factors” may be used somewhat interchangeably, with the former used to refer to factors in general, and the latter used to refer to factors that have already been observed.

At 202, a medical product may be launched. In the case of pharmaceuticals, launch may occur after approval is obtained from the appropriate authorities (e.g., the FDA). Launching a medical product may include but is not limited to deploying sales representatives to offer for sale and to sell medical products to providers such as health care professionals and organizations such as health clinics, hospitals, manages care plans and so forth. At 204, data relevant to the medical product's adoption or utilization may be collected. The nature of this data and examples of how it may be collected are described below. In FIG. 2, 204 occurs after 202 because, in various embodiments, data may be collected post-launch. That is when sales representatives are able to provide data that is particularly useful in determine a product's readiness for adoption. However, it should be understood that disclosed methods may be performed in various orders that differ from that shown in FIG. 2. For example, data collected at 204 may be collected prior to the product being launched, and may relate to a different medical product to which the new medical product is expected to perform similarly.

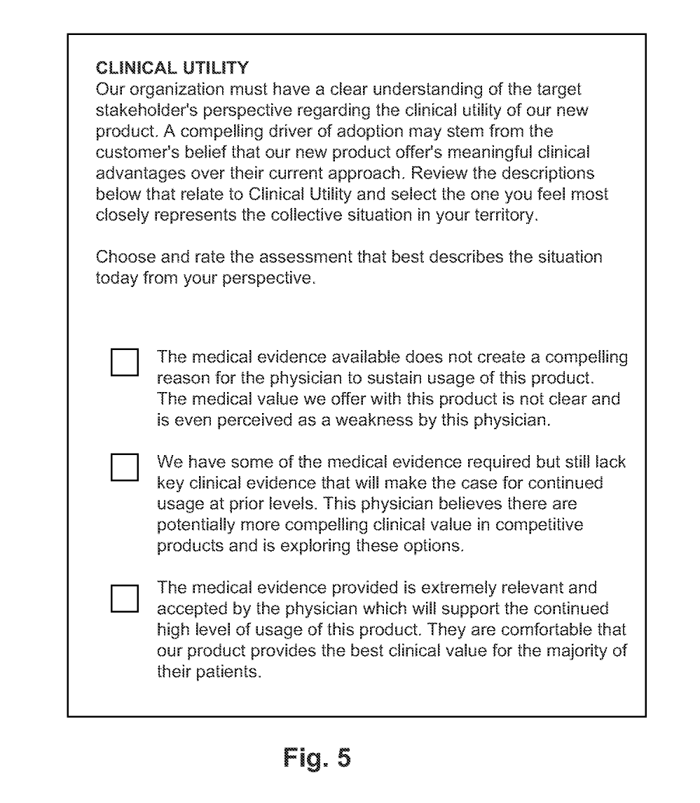

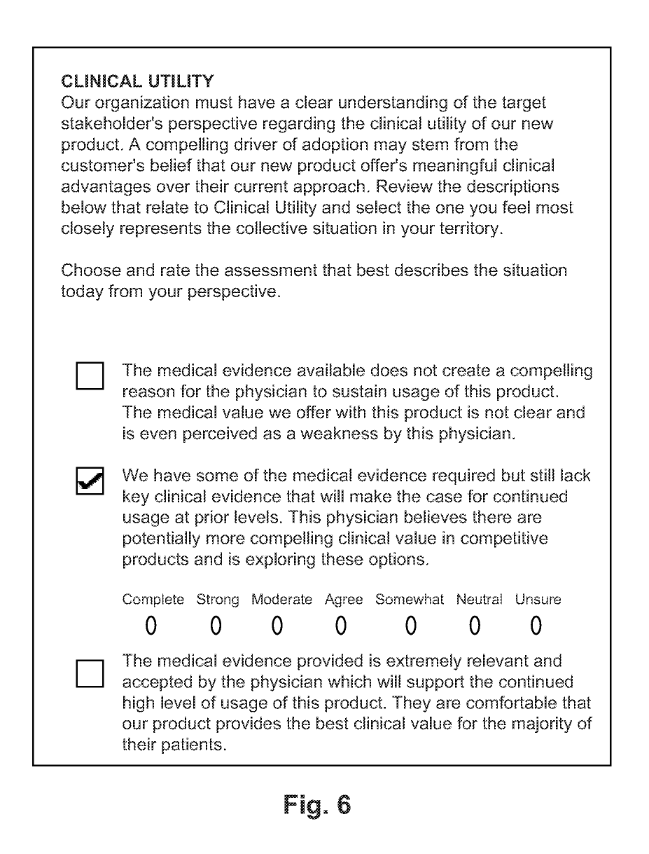

In any case, at 204, data may be obtained from various sources, including sales representatives who have an opportunity to directly observe provider behavior and other factors that may relate to adoption or utilization of medical products. Data may be collected using various dialogues or interfaces presented by computer programs executing on computing devices such as person computers, laptops, smart phones, tablet PCs, and so forth. An example interface for collection of this data is shown in FIGS. 5 and 6. In some instances, the data collection process may be confidential; e.g., it might not be possible to associate the sales representative's input with his or her identity. In this manner, sales representatives may be more willing to be honest and candid in their responses. In various embodiments, the collected data may be stored in a database, e.g., on application server 12 or on a separate database server (not shown).

At 206, the data collected at 204 may be analyzed to characterize the medical product's readiness for adoption and/or utilization. In various embodiments, a medical product may be characterized and/or categorized by its readiness to be adopted or utilized. In some embodiments, a medical product may be characterized as either a “Market Drifter,” as being “Market Focused” or as being “Market Driven.”

A medical product may be considered a “Market Drifter” where the market is not well prepared or does not currently appear to present significant growth opportunity for the medical product. This may be due to the fact that the market is being well-served by existing competitive products or the market has not yet been developed and the unmet needs articulated. Additionally or alternatively, a Market Drifter may not have achieved significant acceptance from key opinion leaders or other influencer groups. For example, physicians that are enthusiastic about staying current with medical advances and thus are more likely to adopt products early on may be considered “early adopters.” However, with a product that is considered a “Market Drifter,” a target early adopter physician group may not have a compelling need for the product or perceive it as addressing a clear medical need. Lack of demand for the product also may limit the adoption of the product within physicians' practices. A physician may be considered to be in an ‘even keel’ state and not convinced of a compelling need to adopt the new product.

In addition, the medical product launcher who launches a Market Drifter may not have conducted an appropriate competitive or market analysis to truly understand physician need for the product, or they may be ‘late to market’ within a class that is occupied by brands that have been on the market for a while. Without a true sense of the market, launching a Market Drifter medical product may require pushing it through to the customer without having a differential product advantage to address their needs. This approach best reflects a ‘product out’ versus ‘market back’ orientation, and is not likely to prove successful.

A medical product may be considered “Market Focused” where the market is developing and there is a meaningful unmet need the medical product launcher has clearly identified that the product addresses. However, a value proposition of the new medical product may not address the need in a differential manner or it may not be utilized in a broad enough manner to achieve market share objectives. Moreover, the target early adopter physician group may not perceive the product as being unique enough to adopt and prescribe in a broad manner. They might consider limited use of the product—for example for new patient starts—but they may not switch over patients from their existing pool. While the medical product launcher may have developed a product based on a clear market and early adopter physician need, the strength of the medical product may not be compelling enough to insure ready adoption by the target customer in sufficient volume to ensure market success. There may be key aspects of the ‘launch readiness’ dimensions, described below, which are not strong enough to address customer concerns or overcome competitive alternatives.

A medical product may be considered “Market Driven” where there is a high level of demand for the product in the market. The medical product launcher may have an opportunity to capture this opportunity and establish itself as a market leader. This may be evidenced by the medical product launcher having been successful in gaining both approval and acceptance among payers and influential provider groups at national, regional and local levels. There may not have been a clear leader in this market and/or current competing medical products may not be effectively entrenched as market leaders. A high level of demand may enable a compelling value proposition to be communicated clearly to the customer to drive trial, purchase and broad adoption of a medical product.

If a medical product is characterized as “Market Driven,” the medical product launcher may have identified a clear and compelling need and designed a product that addresses this need in a manner that is distinguishable from other options. With a Market Driven product, the medical product launcher may therefore be able to shape the market and capture an advantage over competitors with a compelling product that addresses customer need and alleviates a significant market need. It may be possible for the medical product launcher to become the market leader and drive growth via early adopter physicians who may aggressively switch their existing pools of patients to the launcher's new medical product.

Returning to FIG. 2, at 208, the results may be caused to be presented to a user, e.g., by application server 12. For example, a characterization of a medical product may be presented to a sales representative once he or she completes inputting the collected data (204). Additionally or alternatively, the results may be presented to someone involved with the launch of the medical product, e.g., at medical product launcher computer system 15, so that they can assess the medical product's adoption or utilization.

At 210, a product launcher may use a computer program executing, for instance, on product launcher computer system 15, to view the results of the data collection (204). In addition to viewing the results, values and/or weights assigned to various pieces of data and variables may be manipulated to allow the medical product launcher to test hypothetical scenarios or to determine why a particular product is or is not ready for adoption and/or utilization. In some embodiments, a single interface may be provided, to a medical product launcher for instance, that both presents results and allows for analysis and manipulation of data and variables.

There may be any number of observable factors that may influence adoption or utilization of medical products. In some embodiments, one or more of these observable factors may affect a characterization of a medical product, e.g., whether it is a considered Market Drifter, Market Focused or Market Driven. These observable factors may be identified at various points, including prior to launch of a medical product. For example, for a new medical product entering a crowed market, clinical utility, economic outcomes of using the new medical product versus what already exists, and effectiveness of marketing materials may all potentially be highly influential on adoption or utilization of the new medical product.

Observable factors that are assessed may be chosen by a product launcher, e.g., at product launcher computer system 15, before or after launch of a medical product. Observable factors may be tailored to a specific medical product and/or to a specific market, for example, by more heavily weighting factors that are more likely to influence adoption or utilization of a medical product and assigning less weight to less influential factors.

For example, a particular medical product may be generally considered “alternative” medicine. Some markets, such as traditional medical practitioners, may be skeptical of alternative medicine. Other markets, such as practitioners of Eastern medicine, may be more accepting of alternative medicine. If an alternative medicine is being targeted towards all providers generally, then observable factors such as perception of clinical utility may be highly influential on adoption or utilization of the alternative medicine. However, if the alternative medicine is being targeted specifically towards providers of Eastern medicine or alternative health providers, perceived clinical utility may be less important than, for example, economic outcomes of adopting or utilizing the alternative medicine.

Non-limiting examples of observable factors will now be described. Clinical utility may relate to whether there is compelling and relevant information to support medical value claims associated with the new medical product. Providers such as physicians and other health professionals may be compelled to adopt a new product where the new product appears to offer meaningful clinical advantages over existing products.

Economic outcomes of adopting or utilizing the medical product (also referred to as “Economic Outcomes”) may relate to whether the medical product's economic value proposition is compelling and/or supported by key stakeholders. For example, a physician may tell a sales person that the physician's views a new medical product's economic impact as being positive because, for instance, the operating costs of administering the product are low, other savings will be realized, or the profit margin may be higher than that associated with existing products.

Competitiveness of the medical product against other medical products adopted or utilized by the one or more providers (also referred to as “Competition”) may relate to whether the new medical product addresses early adopter physician needs relative to competitive alternatives. Whether a new medical product is distinct and can be differentiated in a meaningful manner from competitive alternatives is relevant to this dimension.

Effectiveness or potential effectiveness of marketing materials in convincing one or more providers to adopt the first medical product (also referred to as “Sales Tools”) may relate to whether sales representatives feel that the medical product launcher has provided appropriate tools and aides necessary to persuade customers to adopt a new medical product. For example, a sales representative may provide input as to whether the sales tools provide at his or her disposal provide sufficient or compelling enough evidence to persuade early adopter providers to adopt or utilize the medical product. “Product Messaging” may be somewhat similar to “sales tools,” and may evaluate clarity of the medical product's value story which has been developed and is expected to be communicated by sales representatives to target providers such as physicians.

An amount of effort a sales representative is willing to allocate to selling the medical product (also referred to as “Focus”) may relate to whether sales representatives are inclined and willing to commit the time and emphasis required within a particular launch window time period. For example, a sales representative may be asked what degree of focus the sales representative feels is appropriate to allocate to the new medical product over a particular period of time. A sales representative additionally or alternatively may be asked to indicate whether focusing on the new medical product will impact the sales of other medical products by the sales representative, and whether the sales representative is willing to allocate the time and effort being requested by the medical product launcher.

Demand for a medical product by one or more providers (also referred to as “Physician Demand”) may relate to a state of provider demand for the medical product based on their readiness to adopt or utilize. This may be based on input sales representatives receive from providers as to whether the providers are willing or able to identify pools of existing or potential patients for a new medical product. For example, a sales representative may give provide a high score for demand if the product appears to fill an unmet need and is perceived by providers as well-suited for patients.

“Target Physician Access” (also referred to herein as “Practice Stakeholder Access”) may relate to whether a value proposition of a medical product is leading to a quality and quantity of access suitable to achieve sales objectives. For example, a sales representative may indicate that providers in a particular region are likely or not likely to meet with the sales representative (due to a lack of a compelling reason for an initial sales call or other circumstances), or whether the providers will be receptive to adopting or utilizing the medical product.

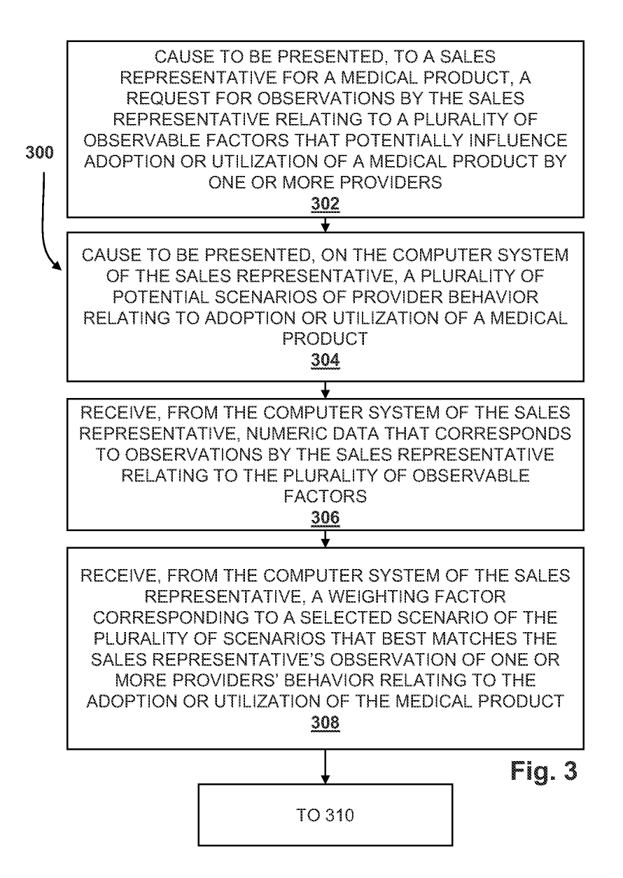

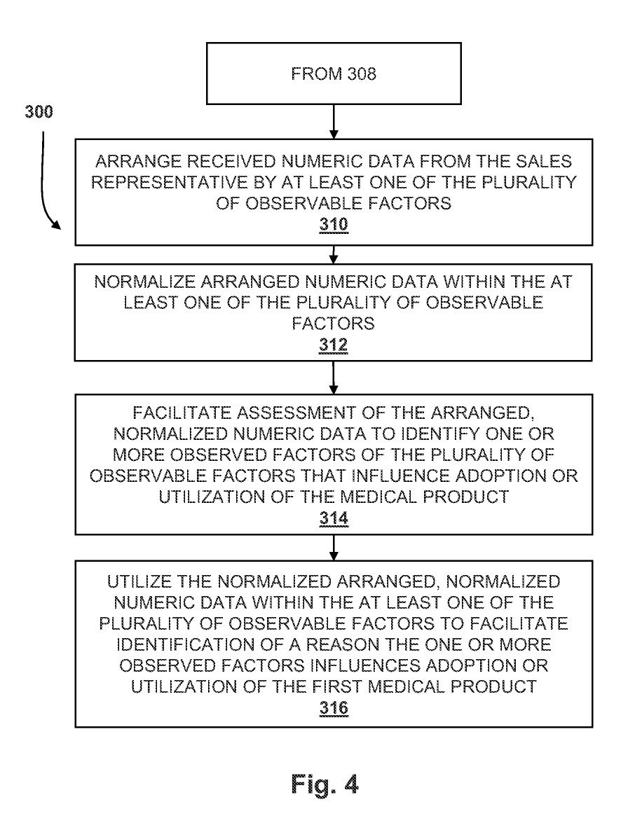

An example method 300 that may be performed by apparatus and/or systems in accordance with various embodiments is shown in FIGS. 3 and 4. At 302, a request for observations by a sales representative, relating to a plurality of observable factors that potentially influence adoption and/or utilization of a medical product, is caused to be presented to a sales representative, e.g., at a sales representative computer system 16.

For example, at 304, application server 12 may cause to be presented to a sales representative at representative computer system 16 a plurality of potential scenarios or provider behavior relating to adoption or utilization of a medical product. An example interface in accordance with various embodiments is shown in FIG. 5, in which a sales representative may select from three potential scenarios relating to adoption or utilization of a medical product. In this example, the interface relates to one of the example observable factors described above, “Clinical Utility,” that may potentially influence adoption or utilization of a medical product.

FIG. 6 depicts an example interface that may follow that shown in FIG. 5. In FIG. 6, a sales representative may be asked to indicate how strongly they agree with the selection made with the interface in FIG. 5. Similar interfaces to those shown in FIGS. 5 and 6 may be used to collect observations from sales representatives regarding other observable factors, such as the non-limiting examples mentioned above.

At 306, numeric data corresponding to observations by the sales representative relating to the plurality of observable factors may be received, e.g., by application server 12 from sales representative computer system 16. For example, at 308, application server 12 may receive from sales representative computer system 16 a weighting factor corresponding to a selected scenario of the plurality of scenarios (e.g., shown in FIG. 5) that best matches the sales representative's observation of the one or more provider's behavior relating to adoption and/or utilization of the medical product.

This is seen in FIG. 5, where a sales representative has selected the second potential scenario—“We have some of the medical evidence required but still lack key clinical evidence that will facilitate broad adoption by physicians”—as the scenario that best matches what the sales representative observed from one or more providers when attempting to market the medical product. In this example, the sales representative has indicated that he or she believes that the absence of key clinical evidence is to blame for a lack of broad adoption and/or utilization of the medical product.

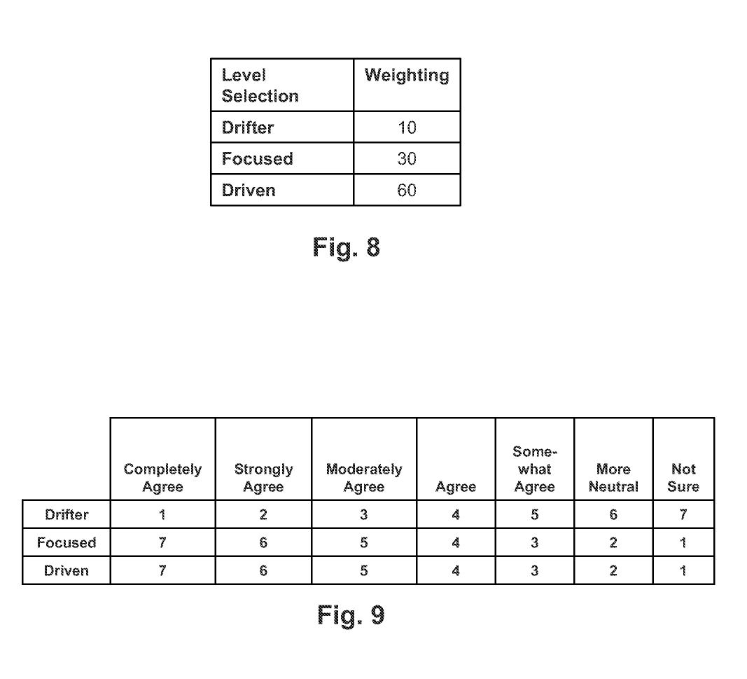

In various embodiments, multiple choice interfaces such as those shown in FIGS. 5 and 6 allow observations to be collected in what appears to a sales representative to be a qualitative manner. Yet, the multiple scenarios may correspond to numeric data such as numeric values and/or weighting factors. For example, and as will be discussed in more detail in relation to FIGS. 8-11, each of the scenarios shown in FIG. 5 may correspond to a numeric weighting factor that may be utilized in calculations to assess adoption or utilization of a medical product. Thus, qualitative selections may yield quantitative data that may be normalized (e.g., automatically and/or continuously by application server 12 or another computer system) and statistically manipulated as described below.

Referring to FIG. 4, at 310, numeric data received from one or more sales representatives may be arranged, e.g., by application server 12, by at least one of the plurality of observable factors. For example, numeric data from sales representatives received through the interface shown in FIG. 5 may be arranged into a portion of memory allocated to a table for holding data related to a group associated with any of the observable factors mentioned above. The numeric data may be in the form of scores or values that may be weighted in various ways in accordance with the observable factor's relative likely influence on adoption or utilization of a medical product.

At 312, the numeric data arranged within each of the observable factors may be normalized. For example, statistical outliers may be eliminated to avoid skewing later assessment and analysis. This may facilitate comparisons and benchmarking of adoption or utilization of a medical product across disparate and complex medical practices, reimbursement systems, regions, demographics, and so forth.

At 314, assessment of the received, arranged and/or normalized numeric data may be facilitated to identify one or more observed factors of the observable factors (e.g., “Clinical Utility”) that influence adoption or utilization of the medical product by one or more providers. For example, numeric data reflecting observations from sales representatives reveal may a general belief that marketing materials for the medical product are inadequate or unpersuasive, in which case effectiveness or potential effectiveness of marketing materials may be identified as an observed factor that is influencing adoption or utilization of a medical product.

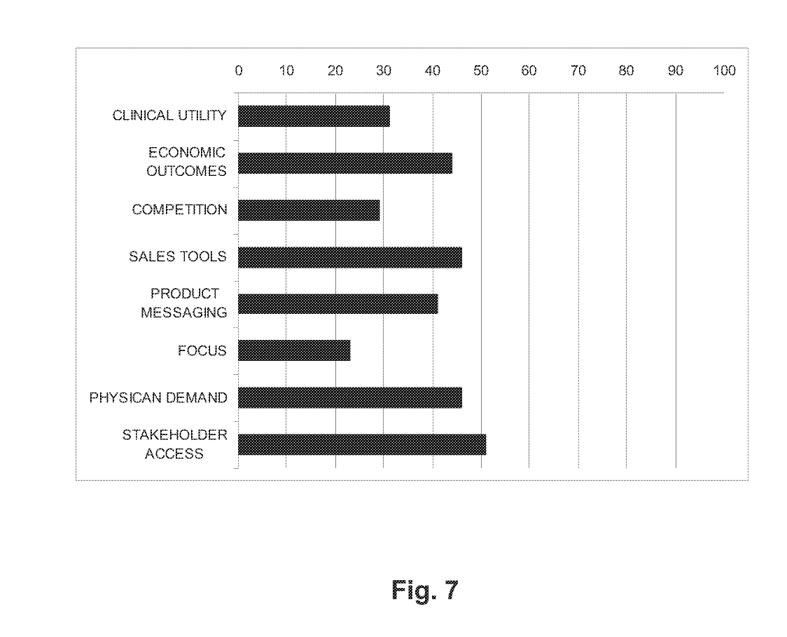

An example chart that may be used to view how much one or more observable factors may influence adoption or utilization of a medical product is shown in FIG. 7. In this example, the observable factors are sorted (top to bottom) based on their relative importance or influence of adoption or utilization of a medical product. Clinical Utility is the most important and has been scored with a 31%. While not shown in FIG. 7, in various embodiments, a heat map may be positioned underneath the chart to demonstrate, using colors or other visual indicia, how the scores compare to predetermined thresholds. For example, different background colors may correspond to the medical product characterizations described above. If Clinical Utility lies within a first region having a first background color, at least as far as the medical product's perceived Clinical Utility is concerned, the medical product may be considered a Market Drifter. Other observed factors in FIG. 7 (e.g., Sales Tools, Physician Demand, Practice Shareholder Access) have higher scores that may cause the medical product to be considered differently in terms of those observed factors. Because Clinical Utility is the most important in this example and has a relatively low score, the numeric data arranged and normalized by this factor may be assessed in more detail, e.g., at product launcher computer system 15, to determine why perceived clinical utility is low.

Returning to FIG. 4, at 316, the normalized, arranged observations may be utilized within one or more of the observed factors to facilitate identification of one or more reasons the observed factor is influencing adoption or utilization of a medical product. This enables not only which observed factor is influencing adoption or utilization, but a more granular assessment of why that observed factor is influencing adoption or utilization. This may include performing regression analysis on the data using, as possible variables that may be manipulated, demographic information relating to providers, sales representatives or even general populations.

For example, it may have been determined at 314, using a chart such as that shown in FIG. 7, that a Clinical Utility score is especially low for a medical product. This may indicate that at least some providers of the medical product may not be convinced of the medical product's usefulness. At 316, other data, such as demographic information about the sales representatives, the providers, or even the general population that includes patients treated by the providers, may be manipulated and utilized to determine with more granularly why observed Clinical Utility score is low. It might be that urban providers are more easily persuaded that a medical product has clinical utility than rural providers. For example, if a heat map similar to the one shown in FIG. 7 is generated using only rural providers and excluding urban providers, the “Clinical Utility” score may be even lower. Efforts may then be increased to convince rural providers of a medical product's Clinical Utility.

The amount of data collected, both from sales representatives and about them and other parties such as providers may be very large. Additionally, the number of variables that may be adjusted to perform regression analysis may be large, and the process of calculating scores resulting from variable adjustment may be complex and time-consuming.

For example, in one embodiment, eight observable factors may be defined and used as bases for obtaining observations from sales representatives. For each sales representative, two data points may be collected for each observable factor. A particular medical product may be sold by hundreds or thousands of sales representatives. There also may be any number of demographic data points relating to the sales representative, one or more providers, and so forth that may add dozens, hundreds or even more additional data points. Accordingly, disclosed systems and methods may be implemented on one or more computer systems, such as application server 12, so that, for example, memory may be allocated to tables and numeric data may be stored in those tables, for arrangement and/or normalization by a processor.

In some embodiments, assessments of blocks 314 and/or 316 may include application server 12 automatically and systematically adjusting various variables, as well as calculating and outputting the results (e.g., to a file or to a database). These results may be viewed later (e.g., at product launcher computer system 15), or they may be viewed in real time as they are produced. In various embodiments, if adjusting a particular variable affects a particular observable factor score (or a total score of aggregate observable factors) more significantly than adjusting other variables, then that variable and any related correlations may be output to a user or to a file or database. In some embodiments, a corresponding report may be generated and provided to appropriate users.

For example, if a Clinical Utility score for a medical product is low (e.g., below a predetermined threshold or within a range of a particular characterization, such as Market Drifter), a computer system such as application server 12 may automatically cycle through, adjust and/or limit a range of any number of variables to calculate effects of those adjustments or limitations on Clinical Utility. For example, various demographic groups (e.g., providers in certain areas, providers within a certain age or experience range, sales representatives within a certain age or experience range, providers of a particular specialty, etc.) may be assessed automatically by adjusting one or more variables and outputting the results. If a particular demographic group yields a score that is skewed from other groups (e.g., more than a selectable threshold), that may be reported to an appropriate user. For instance, the various demographic groups may be systematically analyzed by application server and it may be determined that providers within a particular experience range perceive a medical product as having significantly less Clinical Utility than providers in other experience ranges.

An example of how numeric data received from sales representatives may be used to assess adoption or utilization of a medical product, in accordance with various embodiments, will now be described. Recall that, in FIG. 5, the sales representative is presented with three potential scenarios from which to select. Although not communicated to the sales representative, these selections may correspond with various characterizations of a medical product in terms of its adoption or utilization. In various embodiments, these selections may also correspond with numeric values such as weighting factors. For example, selection of the bottom choice in FIG. 5 may indicate that, at least as far as Clinical Utility is concerned, the medical product is a Market Drifter. Selection of the middle choice may indicate that the medical product is Market Focused, and selection of the top choice may indicate that the medical product is Market Driven. FIG. 8 depicts an example table that relates the three categories—Market Drifter, Market Focused and Market Driven—to various weighting factors. These weighting factors may be used to perform various calculations to assess adoption or utilization of a medical product.

Once the sales representative makes a selection, the interface may change to resemble that shown in FIG. 6, and the user may be requested to provide an indication of how strongly the user feels about his or her selection from the initial three choices of FIG. 5. FIG. 9 depicts an example table that relates the strength selection of FIG. 6 to various numbers. These numbers may be used, e.g., in conjunction with the weighting factors of FIG. 8, to perform various calculations to assess adoption or utilization of a medical product.

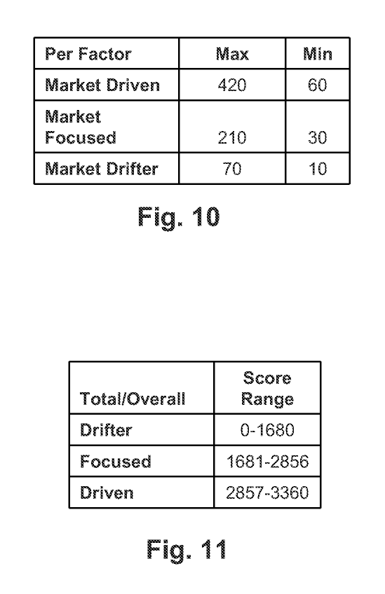

For example, if a sales representative selects the top choice in the interface of FIG. 5 and completely agrees in the interface of FIG. 6, then in effect the sales representative has indicated a very strong belief that the product has a lo perceived Clinical Utility (e.g., is a Market Drifter). Using the tables of FIGS. 8 and 9, the “Drifter” weighting (10) may be multiplied by the number associated with “Completely Agree” for a “Drifter” (1), yielding a Clinical Utility score of 10. As shown in FIG. 10, which shows ranges of characterizations per observable factor, the Clinical Utility score is at the bottom of the range (10-70) for being considered a Market Drifter, and outside of the ranges to be considered Market Focused or Market Driven. This may suggest that investing significant effort into improving the medical product's perceived Clinical Utility would be warranted.

As another example, in FIG. 5 the sales representative selected the second option (corresponding to Market Focused), and assume that, in FIG. 6 the sales representative selects “Strongly Agree.” The “Focused” weighting (30) of FIG. 8 may be multiplied by the number associated with “Strongly Agree” (6) in the table of FIG. 9, yielding a Clinical Utility score of 180. As shown in FIG. 10, the Clinical Utility Score falls closer to an upper end of a range of scores (30-210) for being considered Market Focused, and even within the range of being considered Market Driven.

Clinical Utility is only one example of an observable factor. Any number of observable factors such as those described above may be utilized to assess adoption or utilization of a medical product. Moreover, in addition to assessing individual factors, a plurality of factors may be assessed in the aggregate. Even if one observable factor has a high score, suggesting that, insofar as that factor is concerned, the medical product is Market Driven, Market Focused or a Market Drifter, the scores of all observable factors collectively may tell a different story.

For example, FIG. 11 depicts a table showing example numeric ranges of aggregate observable factor scores that may be exhibited by a Market Drifter, Market Focused and Market Driven medical product. These numbers may be obtained by summing observable factor scores (e.g., the Clinical Utility score discussed previously). This example assumes that eight total observable factors are analyzed, and uses the weights and other numbers shown in FIGS. 8-10. These numbers may be adjusted up or down, respectively, if more or less observable factors are defined. Moreover, while specific numbers are used in these examples, other numbers may be used without departing from the disclosure.

Assume that eight observed factor scores of 180 are assessed. This may occur if a sales representative selected the Market Focused Selection (e.g., FIG. 5) and the “strongly agree” choice (e.g., FIG. 6) for each observable factor. According to the table of FIG. 10 this would place the medical product squarely within the Market Focused range for each observable factor. However, the total score (180×8=1440) may merely fall near the upper end of the Market Drifter range of FIG. 11. The same would be true if the user selected the Market Focused option (weight=30) for all observable factors and strongly agreed (7) with each selection. This would yield a total score of 1680, which still places the medical product in the Market Drifter category, though at the very top. In this example, a medical product may be, in terms of its total score across all dimensions, considered Market Driven only where a user selects at least one Market Driven selection.

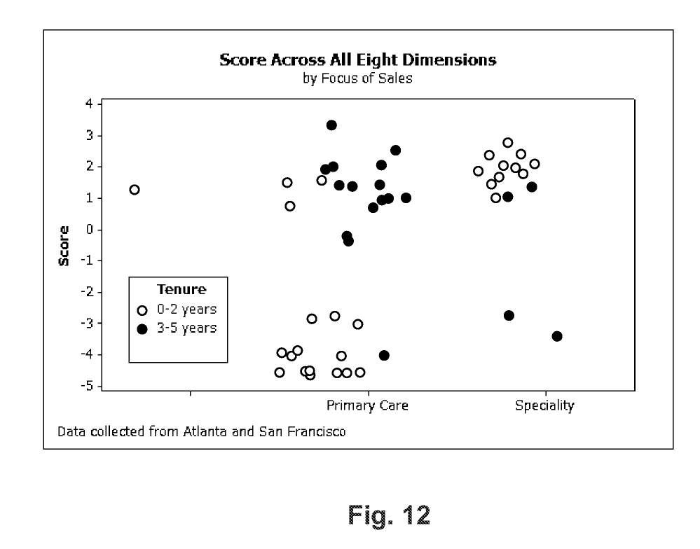

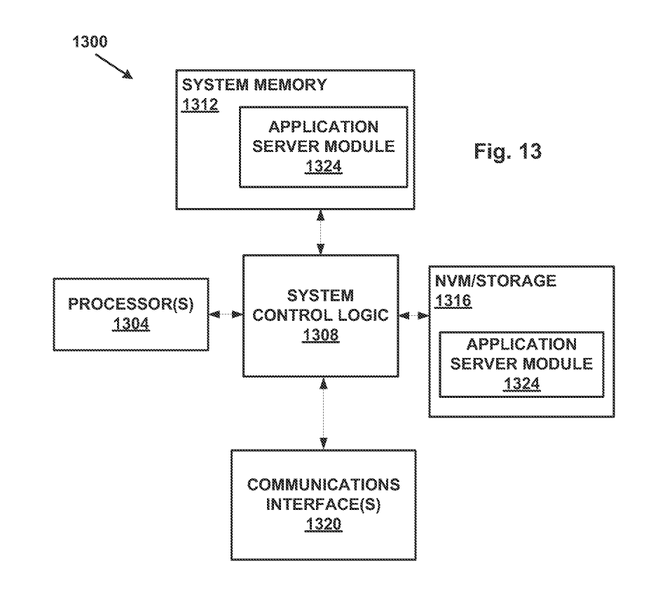

FIG. 12 depicts an example scatter plot that may be viewed, e.g., at launcher computer system 15, to assess adoption or utilization of a medical product. The plotted data relates to an observable factor, focus of sales, and includes two sets of data: data from sales representatives having 0-2 years tenure and data from sales representatives having 3-5 years tenure. Each data point may represent input from a particular sales representative. The Y-axis may correspond to a “Score,” that may be proportional to an observable factor score. For example, a data point that is near the top of the Y-axis may indicate that a sales representative is willing to focus heavily on sales of the medical product in question. A number of individual high scores may collectively indicate that an observable factor score for all salesmen would qualify the medical product as, at least as far as Focus of Sales, Market Driven.

In this example, more tenured sales representatives serving primary care providers appear to be willing to dedicate a relatively large amount of resources to selling the medical product. In contrast, there are approximately equal numbers of more tenured sales representatives serving specialty providers that are willing to dedicate relatively large and relatively small amounts of resources to selling the product. This is less suggestive of an overall trend, and may indicate that additional regressive analysis is warranted. For example, demographic data of the sales representatives serving specialty providers may be manipulated to determine if, e.g., rural sales representatives are more willing to dedicate resources to selling the medical product than urban sales representatives.

As an additional example, a majority of less-tenured sales representatives serving primary care providers appear to be relatively unwilling to dedicate significant resources to selling the medical product. As another example, a majority of less-tenured sales representatives serving specialty providers appear to be relatively willing to dedicate significant resources. The differences between more-tenured and less-tenured sales representatives in terms of willingness to dedicate resources to selling the medical product may indicate that further regressive analysis is warranted. For example, the data in FIG. 12 is collected from two markets, Atlanta and San Francisco. A user of launcher computer system 15 may manipulate demographic data to assess sales in these markets individually, to see if location is related to sales representatives' willingness to focus on sales of the medical product.

The techniques and apparatus described herein may be implemented into a system using suitable hardware and/or software to configure as desired. FIG. 13 illustrates, for one embodiment, an example system 1300 including one or more processor(s) 1304, system control logic 1308 coupled to at least one of the processor(s) 1304, system memory 1312 coupled to system control logic 1308, non-volatile memory (“NVM”)/storage 1316 coupled to system control logic 1308, and one or more communications interface(s) 1320 coupled to system control logic 1308.

System control logic 1308 for one embodiment may include any suitable interface controllers to provide for any suitable interface to at least one of the processor(s) 1304 and/or to any suitable device or component in communication with system control logic 1308.

System control logic 1308 for one embodiment may include one or more memory controller(s) to provide an interface to system memory 1312. System memory 1312 may be used to load and store data and/or instructions, for example, for system 1300. System memory 1312 for one embodiment may include any suitable volatile memory, such as suitable dynamic random access memory (“DRAM”), for example.

System control logic 1308 for one embodiment may include one or more input/output (“I/O”) controller(s) to provide an interface to NVM/storage 1316 and communications interface(s) 1320.

NVM/storage 1316 may be used to store data and/or instructions, for example. NVM/storage 1316 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disk (“DVD”) drive(s) for example.

The NVM/storage 1316 may include a storage resource physically part of a device on which the system 1300 is installed or it may be accessible by, but not necessarily a part of, the device. For example, the NVM/storage 1316 may be accessed over a network via the communications interface(s) 1320.

System memory 1312 and NVM/storage 1316 may include, in particular, temporal and persistent copies of an application server module 1324 (e.g., that may execute on 12), respectively. The application server module 1324 may include instructions that when executed by at least one of the processor(s) 1304 result in the system 1300 performing operations to request behavioral data from sales representatives of a medical product, arrange and normalize and/or data, and/or facilitate assessment of the data received from sales representatives, as described above. In some embodiments, the application server module 1324 may additionally/alternatively be located in the system control logic 1308.

Communications interface(s) 1320 may provide an interface for system 1300 to communicate over one or more network(s) and/or with any other suitable device. Communications interface(s) 1320 may include any suitable hardware and/or firmware.

For one embodiment, at least one of the processor(s) 1304 may be packaged together with logic for one or more controller(s) of system control logic 1308. For one embodiment, at least one of the processor(s) 1304 may be packaged together with logic for one or more controllers of system control logic 1308 to form a System in Package (“SiP”). For one embodiment, at least one of the processor(s) 1304 may be integrated on the same die with logic for one or more controller(s) of system control logic 1308. For one embodiment, at least one of the processor(s) 1304 may be integrated on the same die with logic for one or more controller(s) of system control logic 1308 to form a System on Chip (“SoC”).

The system 1300 may be a desktop or laptop computer, a mobile telephone, a smart phone, or any other device adapted to operate a client or server portion of a client-server application. In various embodiments, system 1300 may have more or less components, and/or different architectures.

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A system comprising:
an application server including a processor, a network interface and a non-transitory computer-readable memory, wherein the non-transitory computer-readable memory stores:
numeric data gathered by one or more sales representatives that corresponds to observations by the one or more sales representatives of behavior of one or more providers of a first medical product; and
instructions that, when executed by the processor, facilitate assessment of the numeric data gathered by the one or more sales representatives to identify one or more observed factors that influence adoption or utilization of the first medical product or that will potentially influence adoption or utilization of a second medical product.

2. The system of claim 1, wherein the non-transitory computer-readable memory further stores:
a plurality of potential scenarios of provider behavior relating to adoption or utilization of a medical product; and
instructions that cause the processor to:
transmit through the network interface, to a first sales representative at a computer system of the first sales representative, the plurality of scenarios; and
receive through the network interface, from the computer system of the first sales representative, a weighting factor corresponding to a selected scenario of the plurality of scenarios that best matches the first sales representative's observation of one or more providers' behavior relating to the adoption or utilization of the first medical product.

3. The system of claim 1, wherein the non-transitory computer-readable memory further stores:
a plurality of observable factors that potentially influence adoption or utilization of the first medical product by the one or more providers;
instructions that cause the processor to transmit through the network interface, to a computer system of a first sales representative, a request for observations by the first sales representative relating to one or more of the plurality of observable factors.

4. The system of claim 3, wherein the identified observed factors that influence market performance of the first medical product or that will potentially influence adoption or utilization of a second medical product are selected from the plurality of observable factors that potentially influence adoption or utilization of the first medical product by the one or more providers.

5. The system of claim 3, wherein the plurality of observable factors include one or more of demand for the first medical product by the one or more providers and ability of the first sales representative to gain access to the one or more providers to market the first medical product.

6. The system of claim 3, wherein the plurality of observable factors include one or more of clinical utility of the first medical product, economic outcomes of adopting or utilizing the first medical product, and competitiveness of the first medical product against other medical products adopted or utilized by the one or more providers.

7. The system of claim 3, wherein the plurality of observable factors include one or more of effectiveness or potential effectiveness of marketing materials in convincing the one or more providers to adopt the first medical product, and an amount of effort the first sales representative is willing to allocate to selling the first medical product.

8. The system of claim 3, wherein the non-transitory computer-readable memory further stores instructions that cause the processor to:
arrange the numeric data gathered by one or more sales representatives in a portion of the non-transitory computer-readable memory allocated to tables by at least one of the plurality of observable factors; and
normalize the arranged numeric data within the at least one of the plurality of observable factors.

9. The system of claim 8, wherein the non-transitory computer-readable medium further stores instructions that cause the processor to utilize the normalized arranged data within the at least one of the plurality of observable factors to facilitate identification of a reason the one or more observed factors influences adoption or utilization of the first medical product.

10. The system of claim 9, wherein the non-transitory computer-readable medium further stores:
demographic information about the one or more providers; and
instructions that cause the processor to facilitate identification of the reason the one or more observed factors influences adoption or utilization of the first medical product based at least in part on the demographic information about the one or more providers.

11. The system of claim 9, wherein the non-transitory computer-readable medium further stores:
demographic information about the one or more sales representatives; and
instructions that cause the processor to facilitate identification of the reason the one or more observed factors influences adoption or utilization of the first medical product based at least in part on the demographic information about the one or more sales representatives.

12. The system of claim 9, wherein the non-transitory computer-readable medium further stores:
demographic information about a general population that includes patients treated by the one or more providers; and
instructions that cause the processor to facilitate identification of the reason the one or more observed factors influences adoption or utilization of the first medical product based at least in part on the demographic information about the general population that includes patients treated by the one or more providers.

13. The system of claim 3, wherein the non-transitory computer-readable medium further stores rankings indicative of relative influence of each the plurality of observable factors on adoption or utilization of the first medical product.

14. A computer-implemented method, comprising:
transmitting, by a processor through a network interface, to a computer system of a sales representative for a medical product, a request for observations by the sales representative relating to a plurality of observable factors that potentially influence adoption or utilization of the medical product by one or more providers;
receiving, by the processor through the network interface, from the computer system of the sales representative, numeric data representing observations by the sales representative relating to the plurality of observable factors; and
storing, by the processor, the received numeric data in a relational database;
facilitating, by the processor, assessment of the received numeric data in the relational database to identify one or more observed factors of the plurality of observable factors that influence adoption or utilization of the medical product.

15. The computer-implemented method of claim 14, wherein the request for observations by the sales representative includes a request for observations of behavior of the one or more providers of the medical product.

16. The computer-implemented method of claim 14, further comprising:
arranging, by the processor, the numeric data within the relational database by at least one of the plurality of observable factors;
normalizing, by the processor, the arranged numeric data associated with the at least one of the plurality of observable factors; and
utilizing, by the processor, the normalized arranged numeric data associated with the at least one of the plurality of observable factors to facilitate identification of a reason the one or more observed factors influences adoption or utilization of the first medical product.

17. The computer-implemented method of claim 14, further comprising:
transmitting, by the processor through the network interface, to the computer system of the sales representative, a plurality of potential scenarios of provider behavior relating to adoption or utilization of a medical product; and
receiving, by the processor through the network interface, from the computer system of the sales representative, a weighting factor corresponding to a selected scenario of the plurality of scenarios that best matches the sales representative's observation of a the one or more providers' behavior relating to the adoption or utilization of the medical product.

18. The computer-implemented method of claim 17, wherein the plurality of potential scenarios of provider behavior relating to adoption or utilization of a medical product relates to at least a first of the plurality of observable factors.

19. The computer-implemented method of claim 14, wherein the facilitating, by the processor, assessment of the received numeric data to identify one or more observed factors that influence adoption or utilization of the medical product includes facilitating the assessment based at least in part on one or more of demographic information about the one or more providers, demographic information about one or more sales representatives, or demographic information about a general population that includes patients treated by the one or more providers.

20. A non-transitory computer-readable medium having computer-readable code embodied therein, the computer-readable code comprising instructions configured to enable a computer system, in response to execution of the instructions, to perform a number of operations, including:
transmitting through a network interface, to a computer system of a sales representative for a medical product, a request for observations by the sales representative of behavior by one or more providers relating to adoption or utilization of the medical product by one or more providers;
receiving through the network interface, from the computer system of the sales representative, numeric data representing observations by the sales representative of behavior by the one or more providers relating to adoption or utilization of the medical product by one or more providers;
allocating memory of the computer system for tables to hold the received numeric data;
arranging the received numeric data in the tables by a plurality observable factors that influence adoption or utilization of the medical product;
normalizing the arranged numeric data within each of the plurality of observable factors; and
facilitating assessment of the normalized numeric data in relation to the observable factors to identify one or more observed factors that influence adoption or utilization of the medical product.
